(19) United States
(12) Patent Application Publication
(10) Pub. No.: US 2004/0042105 A1
(43) Pub. Date: Mar. 4, 2004

(54) Method, apparatus, and medium including computer readable code for controlling a hard disc drive

(75) Inventor: Jae-Deog Cho, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/653,202

(22) Filed: Sep. 3, 2003

(30) Foreign Application Priority Data
Sep. 4, 2002 (KR) 2002-53164

(51) Int. Cl. G11B 27/36; G11B 5/09; G11B 21/02

(52) U.S. Cl. 360/31; 360/53; 360/75

(57) ABSTRACT

A method, apparatus, and medium including computer readable code for controlling a hard disc drive. The method includes receiving a write instruction and sensing a temperature around the hard disc drive, enabling a write verify function when the sensed temperature is below a threshold temperature and recording data in a data sector of a disc, reading the recorded data and detecting a recording error, and recording data in a reserved sector of the disc when the recording error is detected. When the recording error is detected while recording data on a magnetic disc in a low temperature mode, then a cycle of recording, reproducing, and error detecting can be repeated several times. Since a sector is reassigned, if an error is detected, and the data is recorded on that reassigned sector, recording and reproducing data to/from a disc can be carried out more reliably at low temperatures.

### BACKGROUND OF THE INVENTION

This application claims the priority of Korean Patent Application No. 2002-53164, filed on Sep. 4, 2002, in the Korean Intellectual Property Office, the disclosure of which is incorporated herein in its entirety by reference.

1. Field of the Invention

The present invention relates to data storage systems, and more particularly, to a method, apparatus, and medium including computer readable code for controlling a hard disc drive to prevent errors while reading a disc that is incorrectly magnetized, while writing data on the disc, due to deteriorated characteristics of a head of the disc drive, and the disc, in a low temperature environment.

2. Description of the Related Art

A hard disc drive is one type of an auxiliary memory device for a computer system. The hard disc drive records data on and/or reproduces data from a disc using a magnetic head. Recently, the capacity of discs have becomes larger, all while the disc size has become smaller. Accordingly, as the density of the disc, measured in units such as BPI (Bits Per Inch) in the circular direction and/or TPI (Tracks Per Inch) in the radial direction, increases, the hard disc drive requires a more precise and faster control method and a more elaborate mechanism for positioning the head in relation to the disc.

Typically, it is more difficult to record data on a recording medium at low temperatures than at normal or high temperatures. There is an increased coercive force Hc of the medium at low temperatures due to a magnetic hysteresis characteristic of the medium. Moreover, a pole tip of a magnetic head is subject to thermal expansion. Due to this thermal expansion characteristic, a pole tip that has a certain size during an initial recording period thermally expands, due to heat generated by a recording current, and becomes thermally saturated after the recording current is applied for a certain time period. Thus, the pole tip retains its original size at low temperatures, but when a recording current begins to flow, in response to a record command, the pole tip begins to thermally expand. After the recording current is applied for a certain time period and, accordingly, temperature increases sufficiently, the pole tip becomes thermally saturated.

Due to such thermal expansion, a flying height of a magnetic head, i.e., the height of the head from a surface of a disc, changes. The flying height during an initial recording period remains quite high until the pole tip is thermally expanded. Thereafter, a reproduced signal or a reproducing error is likely to be affected by a level down effect while reproducing a signal that was recorded during an initial recording period. In a low temperature environment, such reproducing or reading error is even more likely to occur.

As described above, since characteristics of the head, and the disc, deteriorate at low temperatures, a conventional hard disc drive may experience problems recording and/or reproducing data. The disc may be incorrectly magnetized while writing or recording data on the disc, or an error may occur while reading or reproducing data from the disc.

As data storage capacity increases, the track pitch of the disc as well as the size of a write head decrease, and, accordingly, the intensity of magnetization becomes weaker. At low temperature, the disc is subject to a weak write effect that deteriorates a magnetic characteristic of the disc. In consideration of this weak write effect, conventionally, a write verify function was performed in a low temperature mode to repeat writing and reading in accordance with an error rate, obtained by reading and comparing data recorded on the disc in response to a write instruction with original data. However, since the characteristics of the surface of the disc vary between locations on the surface of the disc, the weak write effect and a reading error due to the weak write effect still occur even when the write verify function is performed in particular areas of the disc where the magnetic characteristic worsens at low temperature.

### SUMMARY OF THE INVENTION

To solve the above and/or other problems, an aspect of the present invention is to provide a method and apparatus for controlling a hard disc drive to prevent errors due to deteriorated characteristics of a head and disc in a low temperature environment, while reading a disc that is incorrectly magnetized during the writing of data on the disc. Writing, reading, and error detecting operations can be repeated several times while recording data on the disc, and sector reassigning can be performed with respect to a sector from which an error is detected.

Additional aspects and/or advantages of the invention will be set forth in part in the description which follows and, in part, will be obvious from the description, or may be learned by practice of the invention.

An additional aspect of the present invention is to provide a method of recording data, including receiving a write instruction, sensing a temperature around a disc drive, enabling a write verify function when the sensed temperature is equal to or below a threshold temperature, recording data in a data sector of a disc, reading the recorded data and detecting a recording error, and recording the data in a reserved sector of the disc when the recording error is detected in the detecting of the recording error.

A further additional aspect of the present invention is to provide an apparatus for controlling a disc drive, including a buffer to store data inputted to and outputted from a host computer, a thermal sensor to detect a temperature around the disc drive, and a controller to enable a write verify function when the temperature detected by the thermal sensor is below a threshold temperature, detect for a presence of a recording error by reading and comparing data recorded in a data area sector of a disc with the data stored in the buffer, and seek a reserved track of the disc and generate an instruction to record data in a reserved sector of the disc when the recording error is detected.

An additional aspect of the present invention is to provide a data recording method of recording user data to a user data area of a medium, including detecting a temperature at a recording drive, and recording user data in a reserved area of a medium when the detected temperature is below a threshold temperature.

Lastly, additional aspects of the present invention include providing media including computer readable code controlling at least a computer to implement embodiments of the present invention.

### BRIEF DESCRIPTION OF THE DRAWINGS

These and/or other aspects and advantages of the present invention will become more readily apparent from the following embodiments, taken in conjunction with the accompanying drawings in which:

FIG. 1 illustrates a structure of a hard disc drive, according to an embodiment the present invention;

FIG. 2 illustrates a disc including data areas for recording data and a reserved area having reserved sectors for reassignment of recorded data, according to an embodiment of the present application;

FIGS. 3A and 3B illustrate a format of a sector among a plurality of sectors forming tracks of a disc and a detailed scheme of servo information recorded on a servo sector, respectively, according to additional embodiments of the present invention;

FIG. 4 is block diagram of an apparatus for controlling a hard disc drive, according to an embodiment of the present invention; and

FIG. 5 is a flow chart of a method of controlling a hard disc drive, according to another embodiment of the present invention.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below in order to explain the present invention by referring to the figures.

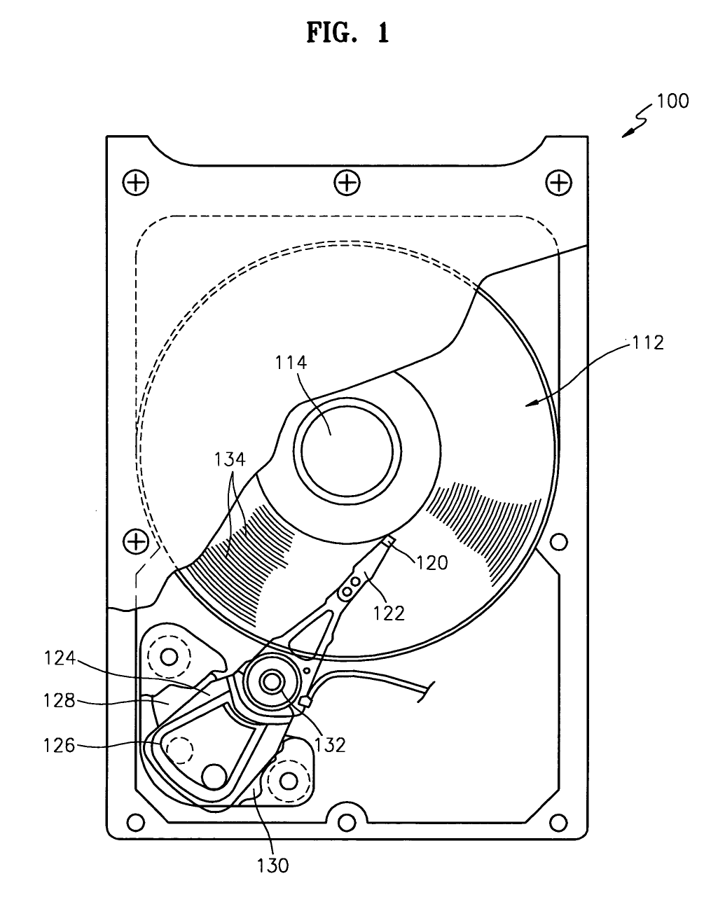

FIG. 1 illustrates a structure of a hard disc drive, according to an embodiment of the present invention. A hard disc drive 100 includes a disc 112, which is rotated by a spindle motor 114. Additionally, the hard disc drive 100 includes a converter (not shown) that is placed adjacent to a surface of the disc 112. The converter can read information from the disc 112 by sensing magnetic fields formed on the surface of the disc 112 or record information on the disc 112 by magnetizing the surface of the disc 112. Although only a single converter is referred in this description, it should be understood that the converter may include a recording converter for magnetizing the disc 112 and a separate reading converter for sensing magnetic fields from the disc 112.

The converter may be integrated with a head 120. The head 120 forms an air bearing between the converter and the surface of the disc 112. The head 120 is mounted to a head stack assembly (HAS) 122, and the head stack assembly 122 is attached to an actuator arm 124 that has a voice coil 126. The voice coil 126 is placed adjacent to a magnetic assembly 128, comprised in a voice coil motor (VCM) 130. A current provided to the voice coil 126 causes a torque to rotate the actuator arm 124, with respect to a bearing assembly 132. The rotation of the actuator arm 124 moves the converter across the surface the disc 112.

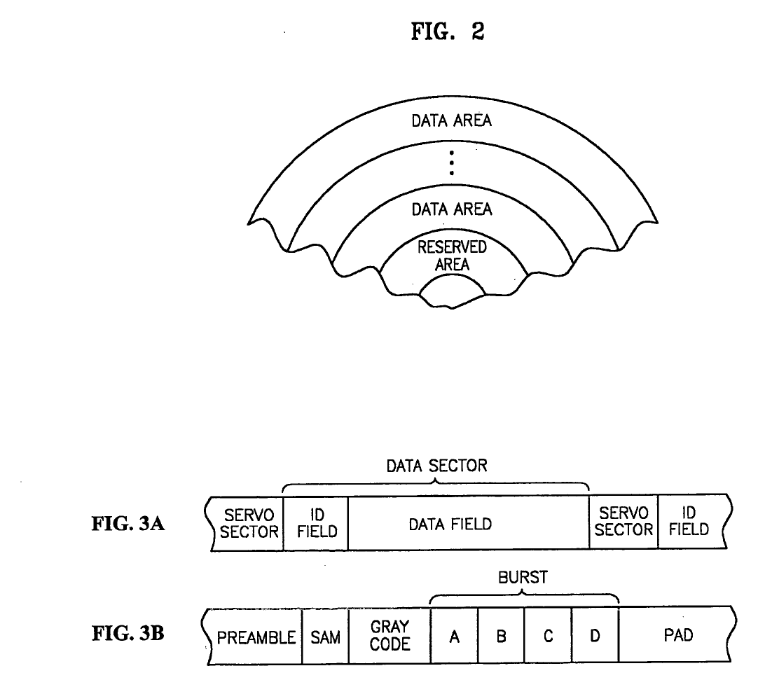

FIG. 2 illustrates a disc including data areas for recording data and a reserved area having reserved sectors for reassignment of recorded data, according to an embodiment of the present invention. To appease recent demands for cheaper and larger capacity hard disc drives, several approaches may be attempted to improve recording density. One approach involves a so-called zone bit recording (ZBR) technology. In zone bit recording, the surface of a disc is divided into a plurality of zones, and each zone has a plurality of tracks. While clock frequencies for recording and reproducing are the same in the same zone, they are different in different zones. Specifically, the frequencies for recording and reproducing increases toward the outer radial edge of the disc. Therefore, by averaging bits per inch (BPI) from an inner area to an outer area of the disc, the recording capacity of the entire disc can be increased. A disc incorporating zone bit recording technology includes reserved sectors and data areas for recording data. The data areas are partitioned from the outermost zone to the innermost zone. Further, an area for data reassignment is provided inside of the innermost zone, and the reserved sectors are placed in that area inside the innermost zone. The area for data reassignment is called a reserved area, and is formed with one or more tracks.

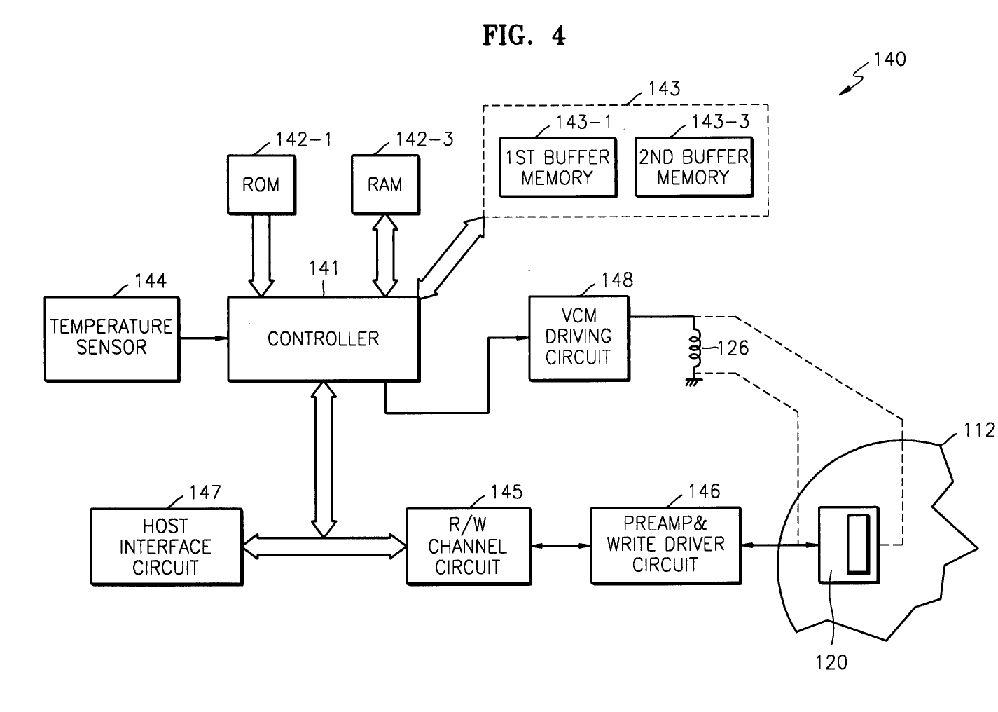

FIGS. 3A and 3B illustrate a format of a sector among a plurality of sectors forming tracks of a disc and a detailed scheme of servo information recorded on a servo sector, respectively, according to embodiments of the present invention. Information is stored in circular tracks of a disc. Typically, the disc includes a data zone where a user's data is recorded, a parking zone where a head is placed while a drive is not in use, and a maintenance cylinder. Generally, each of the tracks includes a plurality of sectors. Each sector comprises a data sector including a data field and an identification (ID) field, and a servo sector including servo information. Additionally, an inter sector gap (ISG) area is provided between each of the data sectors. Digital data is recorded in the data field, and information for identifying a sector and a track or cylinder is recorded in the identification field.

As illustrated in FIG. 3B, the servo information recorded in the servo field includes a preamble, a servo address mark (SAM), a gray code, burst information, and PAD signal. The preamble is also referred to as a servo sync and provides clock synchronization while reading the servo information and, at the same time, indicates the servo sector by providing a gap prior to the servo sector. The SAM indicates a beginning of the servo to provide synchronization for reading the gray code, and provides a reference point for generating timing pulses with respect to the servo control. The gray code provides a track number for each track. The burst information provides a position error signal (PES) required for searching and following tracks. The PAD signal provides a transition margin between the servo sector and the data sector. As described above with reference to FIG. 1, the converter moves across the surface of the disc 112 to read or record information in other tracks.

FIG. 4 is block diagram of an apparatus for controlling a hard disc drive, according to an embodiment of the present invention. The apparatus 140 for controlling a hard disc drive comprises a controller 141, which is connected to a head 120 through a read/write (R/W) channel circuit 145 and a pre-amp and write driver circuit 146. The controller 141 may be a digital signal processor (DSP), a microprocessor, a micro-controller, or the like. The controller 141 provides a control signal to the R/W channel 145 to read data from, or to record data on, the disc 112. Particularly, in a low temperature environment in which the temperature sensed by a temperature sensor 144 is below 10° C., the controller 141 provides a control signal to enable a write verify function and to reassign reserved sectors, where data is reassigned when an error occurs as a result of reading the recorded data and a measuring of a bit error rate. Information is typically transferred from the R/W channel 145 to a host interface circuit 147. The host interface circuit 147 includes a control circuit that allows for interface between a disc drive and a computer system such as a personal computer.

In a reproducing or reading mode, the R/W channel circuit 145 converts an analog signal that is detected by the head 120 and amplified by the pre-amp circuit 146 to a digital signal that can be read by a host computer (not shown), and provides the digital signal to the host interface circuit 147. Further, the R/W channel circuit 145 receives user data from the host computer through the host interface circuit 147, and implements signal processing to convert the user data to a recording current, with the recording current being provided to the write driver circuit 146. The controller 141 is also connected to a voice coil motor (VCM) driving circuit 148 that provides a driving current to a voice coil 126. The controller 141 provides a control signal to the VCM driving circuit 148 to control the flow of current to a VCM and motion of the converter.

The controller 141 is connected to a read only memory (ROM) 142-1, or other non-volatile memory such as a flash memory, and to a random access memory (RAM) 142-3. The memory devices 142-1 and 142-3 store instructions and data to be used by the controller 141 to implement a software routine. As the software routine, there is a seek routine for moving the converter from one track to another and a following routine for finding an objective sector in a track. The seek routine includes a servo control routine for ensuring the moving of the converter to a correct track. The memory devices 142-1 and 142-3 further store, for example, equations for acceleration, speed, and position tracing.

Moreover, the memory devices 142-1 and 142-3 store a program enabling a write verify function and a reassign function, and a threshold temperature value. Therefore, in the event that the temperature sensed by the temperature sensor 144 is below the threshold temperature, the controller 141 can enable the write verify function to be implemented in the low temperature mode. The threshold temperature is based on a temperature at which recording performance begins to drop, in consideration of values such as a contraction rate of a pole tip, a coercive force of a recording medium, etc. The buffer memory 143 includes a first buffer memory 143-1, where data to be recorded is stored in record instructions from the host computer, and a second buffer memory 143-3 where data reproduced from the disk 112 is temporarily stored.

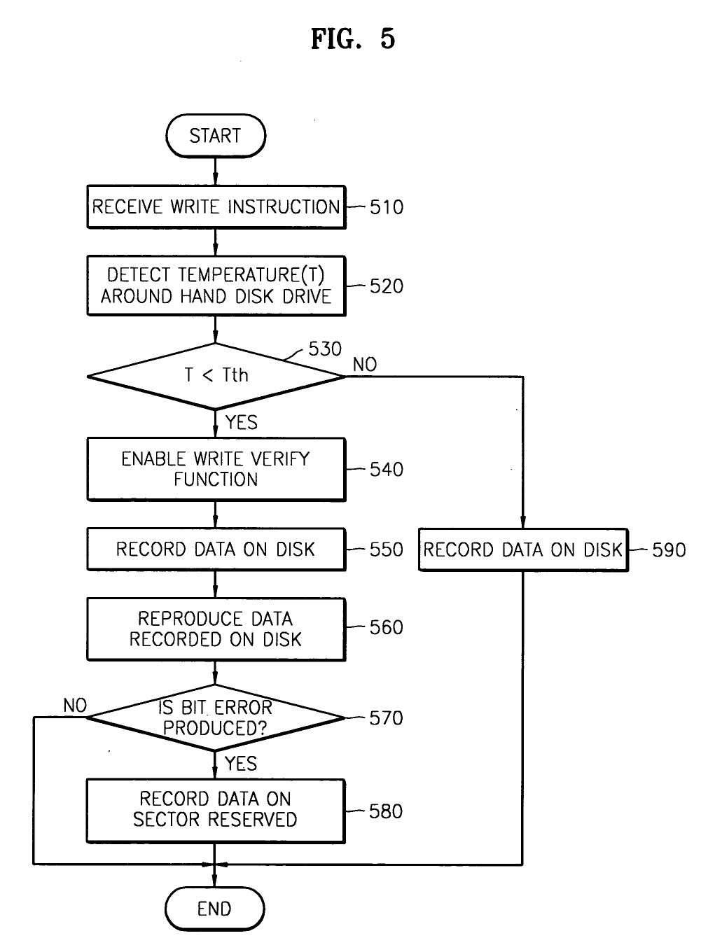

FIG. 5 is a flow chart explaining a method of controlling a hard disc drive, according to an embodiment of the present invention. If the host computer generates a write instruction for recording data, then the first buffer memory 143-1 stores the data to be recorded, and the controller 141 receives the write instruction and searches for an objective track (operation 510). Thereafter, if the temperature sensor 144 detects a temperature T around the hard disc drive (operation 520), then the controller 141 determines whether the temperature T around the hard disc drive is below a threshold temperature Tth (operation 530). As described above, the threshold temperature Tth is a temperature based on when recording performance begins to drop, in consideration of values such as a contraction rate of a pole tip, a coercive force of a recording medium, etc. Generally, the threshold temperature Tth is 10° C.

If the temperature sensed by the temperature sensor 144 is below the threshold temperature Tth, in operation 530, then the write verify function is enabled (operation 540). If the write verify function is enabled, the data subject to the record instruction is recorded in sectors in a data area of the disc by way of a magnetic recording head, included in the head 120 (operation 550). Thereafter, the data recorded on the disc is reproduced by a magnetic reading head of the head 120 (operation 560). The reproduced data is stored in the second buffer memory 143-3. The reproduced data in the second buffer memory 143-3 is then compared with original data stored in the first buffer memory 143-1 to determine whether a bit error is produced (operation 570). If the bit error is produced, in operation 570, then the controller 141 enables a sector reassign function to search a reserved area on the disc 112 and to record the data subject to the record instruction in reserved sectors in the reserved area (operation 580). If the bit error is not produced, in operation 570, then the recording operation ends with the data recorded in the data area. Meanwhile, if the temperature T sensed by the temperature sensor 144 is greater than the threshold temperature Tth, in operation 530, the data stored in the first buffer memory is recorded on the disc (operation 590) and then the recording operation ends.

This sector reassignment technique is a technique that substitutes a reserved sector for a defective sector where an error occurs. Since access to the defective sector is avoided by the sector reassignment technique, user data is safely protected. The sector reassignment function is performed when a write fault is produced. The write fault may be produced in the event that an absolute value of a position error signal (PES), which is detected due to defects in servo information, is great, or in the event that it becomes difficult to detect identification (ID) of a servo sector, due to damage to the ID of the servo sector, or by search errors, etc.

Embodiments of the present invention can be implemented on or by a medium that can be read from or by a computer with a code that is readable by the computer. The medium may include recording devices in which data that is readable by the computer is stored. Examples of the medium further include ROM, RAM, CD-ROM, magnetic tape, magnetic discs, floppy discs, flash memory, optical data storage devices, electrical wave guides, and even carrier wave(s), e.g., transmission over the Internet. Moreover, the medium may be distributed among computer systems that are interconnected through a network, and embodiments of the present invention may be transferred, stored and/or implemented as a code in the distributed system.

As described above, according to the present invention, data or information can be recorded in a stable area, not in a defective sector where an error occurs, using a write verify function and an automatic sector reassign function in a low temperature mode. Therefore, reliability of recording and reproduction of information is improved.

While the present invention has been particularly shown and described with reference to preferred embodiments thereof, it will be understood by those of ordinary skill in the art that various changes in form and details may be made therein without departing from the spirit and scope of the present invention as defined in the claims and their equivalents.

What is claimed is:

1. A method of recording data, comprising:
receiving a write instruction;
sensing a temperature around a disc drive;
enabling a write verify function when the sensed temperature is equal to or below a threshold temperature;
recording the data in a data sector of a disc;
reading the recorded data and detecting a recording error; and
recording the data in a reserved sector of the disc when the recording error is detected in the detecting of the recording error.

2. The method for recording data according to claim 1, wherein the write verify function repeats the enabling of the write verify function, recording of data, reading of the recorded data, and detecting of the recording error for a predetermined time.

3. The method for recording data according to claim 1, further comprising disabling the write verify function if the temperature around the disc drive is detected to be greater than the threshold temperature and then only recording the data in a data area of the disc.

4. The method for recording data according to claim 1, wherein the detecting of the recording error further comprises comparing data stored in a buffer with the read recorded data.

5. The method for recording data according to claim 1, wherein the recording of the data in the reserved sector of the disc further comprises designating one of a plurality of reserved sectors in the disc, which is a magnetic disc, when the recording error is detected, and recovering the data recorded in the data sector and recording that data in the designated reserved sector.

6. The method for recording data according to claim 1, wherein the reserved sector of the disc is in an inner radial reserved area of the disc separate from a user data area of the disc including the data sector.

7. The method of recording data according to claim 1, wherein the recording error is detected based at least on an increased absolute value of a position error signal.

8. The method of recording data according to claim 1, wherein the recording error is detected based on at least a detection of an identification (ID) of a servo sector becoming difficult due to damage to the ID of the servo sector.

9. The method of recording data according to claim 1, wherein the threshold temperature is based on when recording performance begins to drop, in consideration of a contraction rate of a pole tip of the disc drive or a coercive force of the disc.

10. An apparatus for controlling a disc drive, comprising:
a buffer to store data inputted to and outputted from a host computer;
a thermal sensor to detect a temperature around the disc drive; and
a controller to enable a write verify function when the temperature detected by the thermal sensor is below a threshold temperature, detect for a presence of a recording error by reading and comparing data recorded in a data area sector of a disc with the data stored in the buffer, and seek a reserved track of the disc and generate an instruction to record data in a reserved sector of the disc when the recording error is detected.

11. The apparatus for controlling a disc drive according to claim 10, wherein the controller disables the write verify function if the temperature around the disc drive is greater than the threshold temperature, after which the controller records the data in a data area of the disc.

12. The apparatus for controlling a disc drive according to claim 10, wherein the controller designates one of a plurality of reserved sectors in the disc, which is a magnetic disc, when the recording error is detected, and recovers the data recorded in the data sector and records the data in the one reserved sector.

13. The apparatus according to claim 10, wherein the reserved sector of the disc is in an inner radial reserved area of the disc separate from the data area of the disc.

14. The apparatus according to claim 10, wherein the recording error is detected based at least on an increased absolute value of a position error signal.

15. The apparatus according to claim 10, wherein the recording error is detected based on at least a detection of an identification (ID) of a servo sector becoming difficult due to damage to the ID of the servo sector.

16. A data recording method of recording user data to a user data area of a medium, comprising:
detecting a temperature at a recording drive; and
recording user data in a reserved area of a medium when the detected temperature is below a threshold temperature.

17. The data recording method according to claim 16, wherein the recording of the user data to the reserved area further comprises:
recording user data to the user data area;
detecting an error in the recorded user data; and
recording the user data to the reserved area of the medium if an error is detected.

18. A medium comprising computer readable code controlling at least a computer to implement the method of claim 1.

19. A medium comprising computer readable code controlling at least a computer to implement the method of claim 5.

20. A medium comprising computer readable code controlling at least a computer to implement the method of claim 16.

21. A medium comprising computer readable code controlling at least a computer to implement the method of claim 17.
